(19) United States
(12) Patent Application Publication
(10) Pub. No.: US 2014/0118396 A1
(43) Pub. Date: May 1, 2014

(54) IMAGE PROCESSING DEVICE, IMAGE PROCESSING METHOD, AND COMPUTER PROGRAM PRODUCT

(71) Applicant: KABUSHIKI KAISHA TOSHIBA, Tokyo (JP)

(72) Inventors: Kaoru SUGITA, Saitama (JP); Masahiro SEKINE, Tokyo (JP); Shihomi TAKAHASHI, Kanagawa (JP)

(21) Appl. No.: 13/941,895

(22) Filed: Jul. 15, 2013

(30) Foreign Application Priority Data
Oct. 31, 2012 (JP) 2012-240561

(51) Int. Cl. G06T 11/00

(52) U.S. Cl. CPC G06T 11/00
USPC 345/630

(57) ABSTRACT

According to an embodiment, an image processing device includes a first obtaining unit to obtain a first image which contains a clothing image to be superimposed; a second obtaining unit to obtain a second image which contains a photographic subject image on which the clothing image is to be superimposed; a third obtaining unit to obtain, of an image outline of the clothing image, a first outline that is the image outline other than openings formed in clothing; a setting unit to set, as a drawing restriction area, at least some area that is on the outside of the clothing image in the first image and that is continuous to the first outline; and a generating unit to generate a synthetic image by synthesizing the photographic subject image, from which is removed an area corresponding to the drawing restriction area, with the clothing image.

### CROSS-REFERENCE TO RELATED APPLICATIONS

This application is based upon and claims the benefit of priority from Japanese Patent Application No. 2012-240561, filed on Oct. 31, 2012; the entire contents of which are incorporated herein by reference.

### FIELD

Embodiments described herein relate generally to an image processing device, an image processing method, and a computer program product.

### BACKGROUND

Various technologies have been disclosed regarding displaying virtual images of a condition of wearing target clothing for trial fitting. For example, a technology is disclosed for displaying synthetic images of a condition of doing trial fitting of a plurality of articles of clothing on a human body. Moreover, with the aim of providing synthetic images having a natural look; a technology is disclosed by which, in a synthetic image that is formed by superimposing a first clothing image and a second clothing image in this order on a human body image, protruding areas in the first clothing image that protrude from the second clothing image are removed according to the distance to the human body image.

In the conventional technology, from an image formed by synthesizing a plurality of clothing images to be synthesized, a synthetic image is generated by extracting the protruding areas in a first clothing image that protrude from a second clothing image and by removing the protruding areas. Therefore, when it is necessary to generate synthetic images in succession, the synthetic images need to be generated by extracting the protruding areas only after synthesizing a plurality of superimposed clothing images to be synthesized. For that reason, synthetic images having a natural look are difficult to provide at a low processing load.

### BRIEF DESCRIPTION OF THE DRAWINGS

FIG. 1 is a block diagram of an image processing system according to a first embodiment;

FIG. 2 is a schematic diagram illustrating an external appearance of the image processing system according to the first embodiment;

FIG. 3 is a schematic diagram illustrating an exemplary data structure of a table according to the first embodiment;

FIGS. 4A to 4D are schematic diagrams illustrating examples of a clothing image and image outline information;

FIGS. 5A to 5D are schematic diagrams illustrating image deformation according to the first embodiment;

FIGS. 6A and 6B are explanatory diagrams for explaining a drawing restriction area;

FIG. 7 is a flowchart for explaining a sequence of operations performed during the image processing according to the first embodiment;

FIG. 8 is a flowchart for explaining a second image obtaining operation according to the first embodiment;

FIG. 9 is a flowchart for explaining a synthesizing operation according to the first embodiment;

FIGS. 10A and 10B are schematic diagrams illustrating the generation of a synthetic image according to the first embodiment;

FIGS. 11A and 11B are schematic diagrams illustrating a contrast between a conventional synthetic image and the synthetic image generated according to the first embodiment;

FIG. 12 is a schematic diagram illustrating an exemplary data structure of a table according to a second embodiment;

FIG. 13 is a schematic diagram illustrating an exemplary data structure of a table according to a third embodiment;

FIG. 14 is a schematic diagram illustrating an exemplary data structure of a table according to a fourth embodiment;

FIG. 15 is a flowchart for explaining a sequence of operations performed during the image processing according to the fourth embodiment;

FIG. 16 is a schematic diagram illustrating an image processing system according to a fifth embodiment; and

FIG. 17 is a block diagram illustrating an exemplary hardware configuration of image processing devices according to the first to fifth embodiments.

### DETAILED DESCRIPTION

According to an embodiment, an image processing device includes a first obtaining unit to obtain a first image which contains a clothing image to be superimposed; a second obtaining unit to obtain a second image which contains a photographic subject image on which the clothing image is to be superimposed; a third obtaining unit to obtain, of an image outline of the clothing image, a first outline that is the image outline other than openings formed in clothing; a setting unit to set, as a drawing restriction area, at least some area that is on the outside of the clothing image in the first image and that is continuous to the first outline; and a generating unit to generate a synthetic image by synthesizing the photographic subject image, from which is removed an area corresponding to the drawing restriction area, with the clothing image.

Various embodiments will be described below in detail with reference to the accompanying drawings.

### First Embodiment

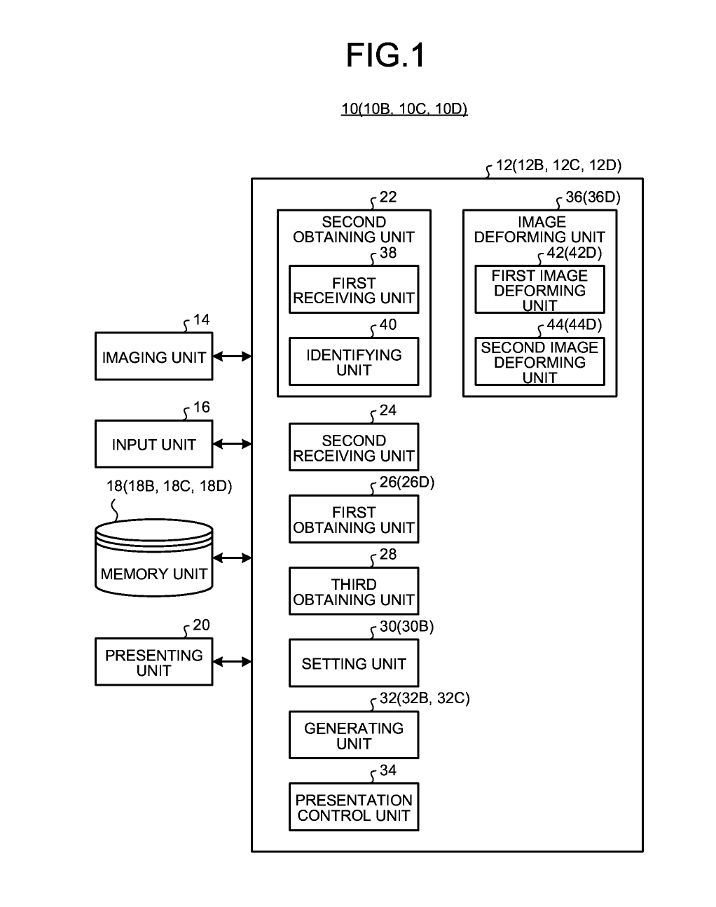

FIG. 1 is a block diagram illustrating a functional configuration of an image processing system 10 according to a first embodiment. The image processing system 10 includes an image processing device 12, an imaging unit 14, an input unit 16, a memory unit 18, and a presenting unit 20.

In the first embodiment, the explanation is given for a case in which the image processing system 10 includes the image processing device 12, the imaging unit 14, the input unit 16, the memory unit 18, and the presenting unit 20 as separate constituent elements. However, alternatively, the image processing system 10 can also include the image processing device 12 that is configured in an integrated manner with at least one of the imaging unit 14, the input unit 16, the memory unit 18, and the presenting unit 20.

The imaging unit 14 captures images of a photographic subject and obtains color images (described later in detail) of the photographic subject. Then, the imaging unit 14 sends the color images of the photographic subject to the image processing device 12. Herein, the photographic subject is the target on which trial fitting of clothing is to be done, and can either be a living object or a non-living material. An example of the living object is a human being. However, that is not the only possible case, and a pet animal such as a dog or a cat can also be taken into account. Examples of the non-living material include a dummy that is formed in the shape of a human being or a pet animal; an article of clothing; and some other object. However, that is not the only possible case. Meanwhile, as the photographic subject, it is also possible to capture images of a living object or a non-living material that is already wearing clothing.

Herein, clothing points to the articles that can be put on the photographic subject. Examples of an article of clothing include a coat, a skirt, pants, a pair of shoes, a hat, and the like.

The presenting unit 20 is a device for presenting various images. In the first embodiment, the presenting unit 20 presents synthetic images (described later) that are generated by the image processing device 12. Moreover, in the first embodiment, presentation of images includes displaying, printing, and sending of the images.

The presenting unit 20 can be, for example, a display device such as a liquid crystal display (LCD) device, or a printing device that prints images, or a known communication device that sends information to an external device by means of wire communication or wireless communication. If the presenting unit 20 is a display device, then it displays synthetic images. If the presenting unit 20 is a communication device, then it sends synthetic images to an external device. If the presenting unit 20 is a printing device, then it prints synthetic images.

The input unit 16 is used by the user to perform various operation inputs. The input unit 16 can be configured, for example, by combining one or more of a mouse, buttons, a remote control, a keyboard, a voice recognition device such as a microphone, and an image recognition device. In the case of using an image recognition device in the input unit 16; the image recognition device can be configured to receive user gestures, which are performed by the user in front of the input unit 16, as various instructions from the user. In this case, in the image recognition device, instruction information corresponding to body motions or gestures can be stored in advance; and operation instructions from the user are received by reading the instruction information corresponding to the recognized gestures.

Alternatively, the input unit 16 can be a communication device that receives signals, which represent operation instructions from the user, from an external device such as a handheld device that sends a variety of information. In this case, as the operation instructions from the user, the input unit 16 can receive signals that represent operation instructions received from an external device.

It is also possible to configure the input unit 16 and the presenting unit 20 in an integrated manner. More particularly, the input unit 16 and the presenting unit 20 can be configured as a user interface (UI) that is equipped with an input function and a display function. An example of the UI is an LCD having a touch-sensitive panel.

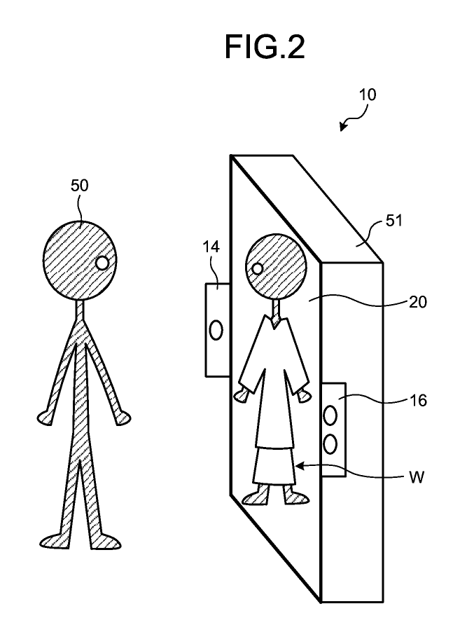

FIG. 2 is a schematic diagram illustrating an external appearance of the image processing system 10.

As illustrated in FIG. 2, in the image processing system 10, the presenting unit 20 is incorporated into one of the faces of a housing 51 that has, for example, a rectangular shape. In the image processing system 10, on the presenting unit 20 is displayed a synthetic image W of a condition in which trial fitting of a variety of clothing is done on a photographic subject 50. The photographic subject 50 such as a human being views the synthetic image W, which is presented on the presenting unit 20, from, for example, a position in front of the presenting unit 20.

The housing 51 supports the input unit 16 and the imaging unit 14. In the example illustrated in FIG. 2, the input unit 16 and the imaging unit 14 are disposed at such positions in the housing 51 which are adjacent to the presenting unit 20. The user operates the input unit 16 and inputs a variety of information via the input unit 16. The imaging unit 14 captures images of the photographic subject 50, and obtains photographic subject images that are the captured images of the photographic subject 50.

The memory unit 18 is used to store, in advance, first images, each of which contains a clothing image that is to be superimposed on a photographic subject image, and image outline information. In the first embodiment, the explanation is given for a case in which the memory unit 18 is used to store a table that contains the first images and the image outline information.

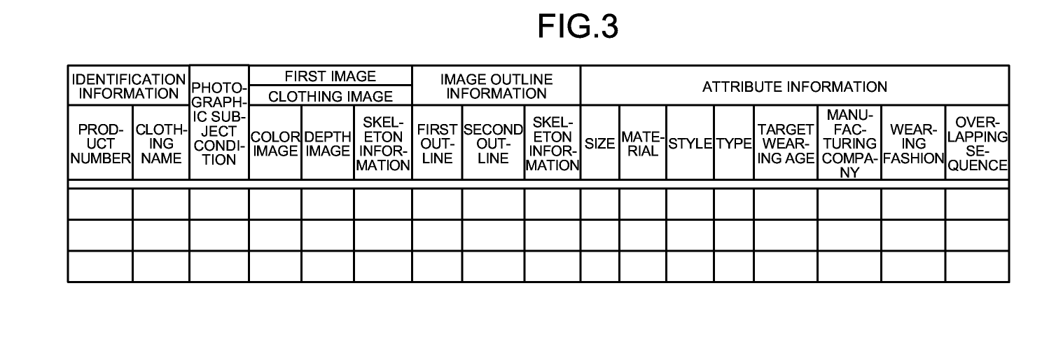

FIG. 3 is a schematic diagram illustrating an exemplary data structure of the table that contains the first images and the image outline information.

As illustrated in FIG. 3, the table containing the first images is used to store, for example, identification information, photographic subject conditions, the first images, the image outline information, and attribute information in a corresponding manner.

The identification information is used in uniquely identifying the clothing images that are included in first images. The identification information can include, for example, product numbers and clothing names. However, that is not the only possible case. The product numbers can be, for example, the Japan Article Numbers (JAN). The clothing names can be, for example, the product names of articles of clothing.

A first image contains a clothing image. Thus, a first image has an area occupied by the clothing image and an area not occupied by the clothing image.

A clothing image contains a color image; a depth image; and skeleton information that serves as posture information. A color image is a bitmap image captured of a condition in which a particular article of clothing is put on a target photographic subject. Thus, for each pixel in a color image, a pixel value is defined that indicates the color of clothing or the brightness of clothing.

A depth image is sometimes called a range image in which, for each pixel constituting a clothing image, the distance from the imaging device which captured that particular clothing image is defined. In the first embodiment, a depth image can be created from the corresponding clothing image by implementing a known method such as stereo matching, or can be obtained by performing imaging using a rangefinder camera under the same imaging conditions as the imaging conditions used in capturing the corresponding clothing image.

The posture information indicates the posture of a photographic subject such as a human being who is the target for wearing the articles of clothing corresponding to the clothing image that is obtained. The posture information indicates the body shape or the orientation of a photographic subject. Herein, the body shape of a photographic subject indicates the skeleton information that is determined by a collection of the positions of the joints or a collection of the angles of the joints of the photographic subject. The orientation of a photographic subject points to the orientation of that photographic subject, who is wearing the articles of clothing corresponding to the clothing image that is obtained, with respect to the imaging device. For example, the orientation of a photographic subject includes the frontal orientation in which the face and the body of the photographic surface is facing the imaging device; a lateral orientation in which the face and the body of the photographic surface is lateral with respect to the imaging device; and some other orientations other than the frontal orientation and the lateral orientation.

In the first embodiment, the explanation is given for a case in which a first image contains the skeleton information as the posture information. More specifically, in the first embodiment, in the skeleton information, the skeleton positions (the positions of joints or the positions of extremity joints) of a living object are represented in two-dimensional coordinates in the clothing image (a color image and a depth image) that is included in a first image.

The photographic subject condition points to the information that indicates the condition of a photographic subject on which trial fitting of articles of clothing is done at the time of obtaining a clothing image that is included in the first image corresponding to the photographic subject condition. In the first embodiment, the photographic subject condition indicates posture information of a photographic subject who is doing trial fitting of articles of clothing corresponding to the clothing image that is obtained. Herein, the posture information has the same meaning as the posture information (in the first embodiment, skeleton information) that is specified in the first image.

The image outline information indicates the image outline of the corresponding clothing image; and contains second outlines, first outlines, and skeleton information.

The second outlines correspond to the openings that are formed in the image outline of the corresponding clothing image. Herein, openings point to the open portions in an article of clothing. More particularly, if the article of clothing is a T-shirt, then the openings point to the portions through which the neck, the arms, and the body are let into while wearing the T-shirt. The first outlines point to the remaining image outline portion other than the openings formed in the image outline of the corresponding clothing image.

In an identical manner to the skeleton information that is specified in a first image, the skeleton information specified in the image outline information indicates the skeleton positions of a living object wearing the articles of clothing having the image outline corresponding to the pixel positions of the pixels of the corresponding second outlines and the pixel positions of the pixels of the corresponding first outlines.

The attribute information indicates the attributes of the corresponding clothing image. Regarding the articles of clothing that are captured in a clothing image; the attribute information contains, for example, the sizes, the materials, the styles, the types, the target wearing ages, the manufacturing companies, the recommended wearing fashions, and the recommended overlapping sequence of those articles of clothing.

When the articles of clothing are classified into predetermined types such as a skirt, pants, and a coat depending on the method of wearing; the types of clothing represent the information indicating such types.

The recommended wearing fashion indicates the recommended fashion of wearing an article of clothing, such as wearing an article of clothing with the buttons open, when put on the photographic subject. Such information can be set in advance by the user who manages the installation site at which the image processing system 10 is installed in advance. Alternatively, it is also possible to set the information provided by the clothing manufacturers of the articles of clothing that are captured in each clothing image.

The overlapping sequence of clothing is the information that, when multiple layers of clothing are put on a human body, indicates the recommended layer for each article of clothing starting from the innermost layer that comes in contact with the human body to the outermost layer that is separated from the human body. Regarding the overlapping sequence of clothing, either it is possible specify in advance the layer for each article of clothing, or it is possible to allow the user to input the information by operating the input unit 16.

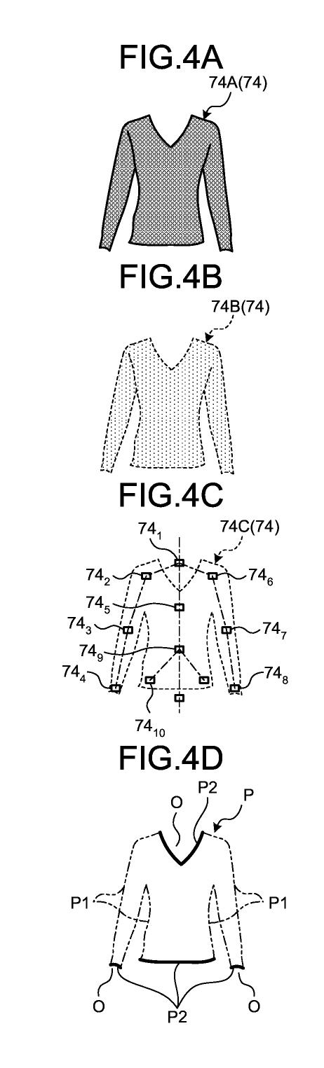

FIGS. 4A to 4D are schematic diagrams illustrating examples of a clothing image and image outline information.

As illustrated in FIG. 4A, for example, a clothing image 74 represents a sweater and contains a color image 74A. As illustrated in FIG. 4B, the clothing image 74 contains a depth image 74B corresponding to the color image 74A. As illustrated in FIG. 4C, the clothing image 74 contains skeleton information 74C in which skeleton positions (for example, a joint 74₁ to a joint 74₁₀) of a human body are represented in two-dimensional coordinates in the color image 74A and the depth image 74B.

The memory unit 18 is used to store outline information of an image outline P, which is illustrated in FIG. 4D, as the image outline information corresponding to the clothing image 74. More specifically, the image outline information contains, the image outline P of the clothing image 74 (see in FIG. 4A), second outlines P2 that correspond to openings O and first outlines P1 that are the image outlines other than the second outlines P2 in the image outline P. Moreover, with respect to each pixel that constitutes each second outline P2 or that constitutes each first outline P1, the image outline information contains skeleton information (not illustrated in FIG. 4D) that indicates the skeleton position of a human body.

As described above, at the time of capturing a clothing image, the corresponding skeleton information is calculated from the posture of the photographic subject wearing the clothing captured in that clothing image. More particularly, the skeleton information can be obtained in advance by applying the human body shape to the corresponding depth image. Meanwhile, the color image, the depth image, and the skeleton information which are identified by respective identification information and which constitute a clothing image need to have a consistent coordinate system by means of performing calibration in advance. In an identical manner, the second outlines, the first outlines, and the skeleton information which are identified by respective identification information and which constitute the image outline information need to have a consistent coordinate system by means of performing calibration in advance.

Returning to the explanation with reference to FIG. 1, the image processing device 12 is a computer that includes a central processing unit (CPU), a read only memory (ROM), and a random access memory (RAM).

Moreover, the image processing device 12 is electrically connected to the imaging unit 14, the input unit 16, the memory unit 18, and the presenting unit 20.

Furthermore, the image processing device 12 includes a second obtaining unit 22, a second receiving unit 24, a first obtaining unit 26, a third obtaining unit 28, a setting unit 30, a generating unit 32, a presentation control unit 34, and an image deforming unit 36.

The second receiving unit 24 receives a variety of information from the input unit 16.

The second obtaining unit 22 obtains a second image that contains a photographic subject image on which clothing images are to be superimposed.

A second image contains a photographic subject image, which in turn contains a color image, a depth image, and posture information. The color image of a photographic subject image is a bitmap image representing the photographic subject image. Thus, for each pixel in the color image of a photographic subject image, a pixel value is defined that indicates the color or the brightness of the photographic subject. The depth image of a photographic subject image is an image in which, for each pixel constituting the photographic subject image, the distance from the imaging device which captured that particular photographic subject image is defined. In the first embodiment, a depth image can be created by implementing a known method such as stereo matching, or can be obtained by performing imaging using a rangefinder camera.

The posture information specified in a photographic subject image points to the information indicating the posture of the photographic subject at the time of capturing the photographic subject image. In the first embodiment, in an identical manner to the posture information described above, the posture information specified in a photographic subject image indicates the posture of the photographic subject. That is, in the posture information specified in a photographic subject image, the skeleton positions of the photographic subject are represented in two-dimensional coordinates in the photographic subject image (the color image and the depth image).

The second obtaining unit 22 includes a first receiving unit 38 and an identifying unit 40.

The first receiving unit 38 receives the color image of a photographic subject from the imaging unit 14. Alternatively, the first receiving unit 38 can receive the color image of a photographic subject from an external device via a communication facility (not illustrated). Moreover, in the case when the imaging unit 14 is equipped with the function of obtaining a depth image, the first receiving unit 38 obtains the color image and the depth image of a photographic subject from the imaging unit 14.

The identifying unit 40 identifies the posture information (the skeleton information) based on the color image of a photographic subject. More particularly, the identifying unit 40 identifies the skeleton information by applying the human body shape to the corresponding depth image. With that, the second obtaining unit 22 obtains a second image that contains the photographic subject image.

The first obtaining unit 26 obtains first images each of which contains a clothing image that is to be superimposed on the photographic subject image included in a second image, which is obtained by the second obtaining unit 22.

In the first embodiment, the first obtaining unit 26 receives clothing candidate information that is used in identifying the clothing images that are to be superimposed. The clothing candidate information contains at least one of the items of attribute information such as the sizes, the materials, the styles, the types, the target wearing ages, the manufacturing companies, and the product names of articles; or contains information that enables identification of at least one of the items of attribute information.

For example, the user operates the input unit 16 and inputs the types, the target wearing ages, and the sizes as the clothing candidate information.

Then, the first obtaining unit 26 analyzes the clothing candidate information received from the input unit 16 and searches the memory unit 18 for a list of clothing images that either are identified by the clothing candidate information or correspond to the attribute information specified in the clothing candidate information. Subsequently, the presentation control unit 34 performs control for presenting the list of clothing images, which is retrieved by the first obtaining unit 26, on the presenting unit 20.

At that time, from among the clothing images that are obtained on the basis of the clothing candidate information received from the input unit 16, it is desirable that the first obtaining unit 26 searches the memory unit 18 for such a list of clothing images which matches with the posture information identified by the identifying unit 40 or which corresponds to such posture information which is closest to the posture information identified by the identifying unit 40. Then, it is desirable that the presentation control unit 34 performs control for presenting the list of clothing images, which is retrieved by the first obtaining unit 26 and which corresponds to the posture information and the clothing candidate information, on the presenting unit 20.

Once the list of clothing images is presented on the presenting unit 20, the user operates the input unit 16 and selects one or more clothing images from that list of clothing images. Then, the information indicating the selected clothing images are output from the input unit 16 to the image processing device 12.

Once the second receiving unit 24 receives the information indicating the selected clothing images, the first obtaining unit 26 identifies, as the first images to be superimposed, the first images each of which contains a clothing image that is identified on the basis of the information about the selected clothing images as received by the second receiving unit 24.

Herein, the first obtaining unit 26 either can identify a single first image as the first image to be superimposed, or can obtain a plurality of first images to be superimposed if the user operates the input unit 16 and selects a plurality of first images.

When a plurality of first images is obtained as the first images each of which contains a clothing image to be superimposed, the first obtaining unit 26 also obtains the sequence of superimposition of the clothing images included in the first images.

The first obtaining unit 26 receives the sequence of superimposition of the clothing images from the input unit 16 via the second receiving unit 24. Moreover, despite the selection of a plurality of clothing images as the clothing images to be superimposed, if the sequence of superimposition of the clothing images is not received from the input unit 16; then the first obtaining unit 26 reads the sequence of superimposition corresponding to the selected clothing images from the memory unit 18 and obtains that sequence of superimposition as the sequence of superimposition of the clothing images.

When the first obtaining unit 26 receives the sequence of superimposition of the clothing images from the input unit 16, the presentation control unit 34 can present, at the time of presenting the list of clothing images on the presenting unit 20, a first instruction button that prompts the user to select the clothing images and a second instruction button that prompts the user to issue an instruction regarding the sequence of superimposition of the clothing images. Subsequently, when the user operates the input unit 16 and uses the first instruction button and the second instruction button, the first images containing the clothing images to be superimposed as well as the information indicating the sequence of superimposition can be input to the second receiving unit 24 from the input unit 16.

In the case of obtaining the sequence of superimposition from the memory unit 18, the first obtaining unit 26 can read from the memory unit 18 the sequence of superimposition of a plurality of first images, which is selected by the user by operating the input unit 16, and accordingly obtain the sequence of superimposition of the clothing images included in the selected first images.

The third obtaining unit 28 obtains the second outlines and the first outlines corresponding to the clothing image that is included in a first image obtained by the first obtaining unit 26. More specifically, the third obtaining unit 28 reads, from the memory unit 18, the second outlines and the first outlines corresponding to the clothing image included in a first image that is obtained by the first obtaining unit 26.

When the first obtaining unit 26 obtains a plurality of first images as the first images containing clothing images to be superimposed; the third obtaining unit 28 obtains the second outlines and the first outlines corresponding to the clothing image included in each first image that is obtained.

The image deforming unit 36 deforms the clothing image included in a first image and changes the first outlines and the second outlines corresponding to that clothing image in such a way that the clothing captured in that clothing image, which is included in the first image obtained by the first obtaining unit 26, takes the shape of the photographic subject having the posture identified by the posture information specified in the second image that is obtained by the second obtaining unit 22.

More specifically, the image deforming unit 36 includes a first image deforming unit 42 and a second image deforming unit 44. The first image deforming unit 42 deforms the clothing image included in a first image. The second image deforming unit 44 changes the image outline information corresponding to the clothing image.

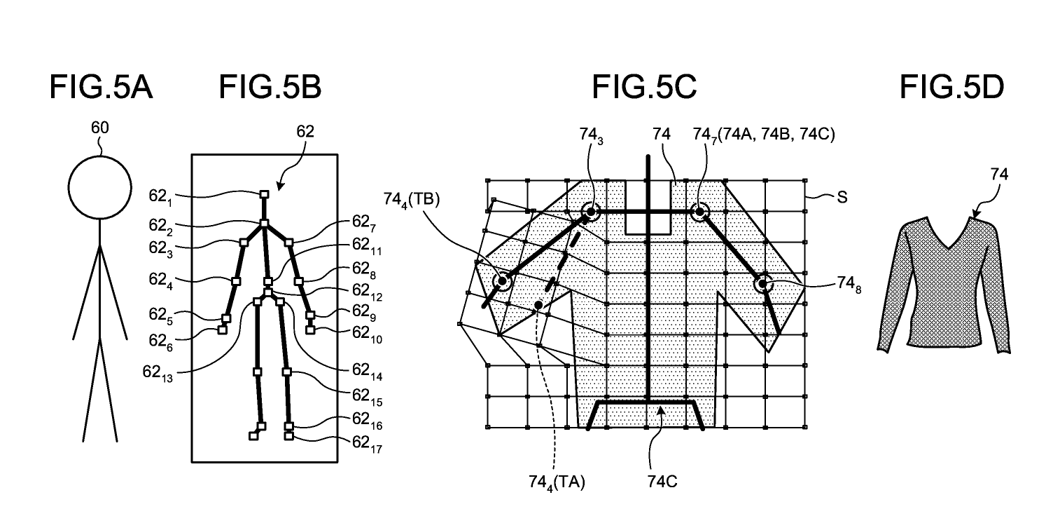

FIGS. 5A to 5D are a schematic diagrams illustrating the image deformation performed with respect to a first image by the first image deforming unit 42.

The first image deforming unit 42 deforms the clothing image included in a first image, which is obtained by the first obtaining unit 26, in such a way that the clothing captured in that clothing image takes the shape of the photographic subject having the posture identified by the posture information that is obtained by the second obtaining unit 22.

Firstly, assume that the second obtaining unit 22 obtains, as a second image, a photographic subject image of a photographic subject 60 (see FIG. 5A). Moreover, assume that the second obtaining unit 22 obtains posture information 62 (see in FIG. 5B) as the posture information specified in the photographic subject image. The posture information 62 is assumed to be skeleton information in which the skeleton positions (for example, a joint 62₁ to a joint 62₁₇) of the photographic subject 60 are determined.

Then, assume that the first obtaining unit 26 obtains a first image that contains the clothing image 74 (see in FIG. 5D). FIG. 5C schematically illustrates the clothing image 74 that is formed by superimposing the color image 74A, the depth image 74B, and the skeleton information 74C in such a way that the pixels at the same pixel positions overlap each other.

In this case, the first image deforming unit 42 deforms the clothing image 74 in such a way that each joint position specified in the skeleton information 74C of the clothing image 74 matches with the joint position specified in each skeleton position (the joint 62₁ to the joint 62₁₇) that is identified by the posture information 62 (the skeleton information) of the photographic subject 60 obtained by the second obtaining unit 22.

More particularly, firstly, the first image deforming unit 42 divides the clothing image 74 into a plurality of grids S. Herein, a straight line joining two joint positions specified in the skeleton information is termed as a bone. Regarding each point of the grids S in the clothing image 74, the first image deforming unit 42 obtains the relative position from the nearest bone. Then, the first image deforming unit 42 moves the pixel positions of the pixels corresponding to the joints in the clothing image 74 to the joint positions of the joints identified by the posture information 62 of the photographic subject 60. Subsequently, the first image deforming unit 42 moves the pixel position corresponding to each intersection point of the grids S in the clothing image 74 in such a way that the relative position from the corresponding nearest bone remains the same. As a result, the joint position in the skeleton information 74C corresponding to each pixel of the clothing image 74 moves so as to reflect the posture information 62 of the photographic subject image of the photographic subject 60 included in the second image. Based on the joint positions that have moved, deformation of the clothing image 74 and the depth image 74B is performed using the free-form deformation (FFD) technique.

For example, the joint 74₄ is associated with the pixel at a pixel position TA. However, the joint (such as the right elbow) that is identified by the joint 74₄ is at the position TA that is away from the position of the joint 62₄ of the right elbow of the photographic subject 60. For that reason, the pixel position TA of the joint 74₄ in the clothing image 74 is shifted to a pixel position TB corresponding to the joint 62₄ of the right elbow of the photographic subject 60. At that time, the pixel position corresponding to each intersection point of the grids S in the clothing image 74 is moved in such a way that the relative position from the corresponding nearest bone remains the same. As a result, the joint position in the skeleton information 74C corresponding to each pixel of the clothing image 74 moves so as to reflect the posture information 62 of the photographic subject image of the photographic subject 60 included in the second image. Based on the joint positions that have moved, deformation of the clothing image 74 and the depth image 74B is performed using the free-form deformation (FFD) technique.

Returning to the explanation with reference to FIG. 1, in an identical manner to the first image deforming unit 42, the second image deforming unit 44 changes the second outlines and the first outlines corresponding to a clothing image, which is included in a first image obtained by the first obtaining unit 26, in such a way that the clothing captured in that clothing image takes the shape of the photographic subject having the posture identified by the posture information that is obtained by the second obtaining unit 22.

The setting unit 30 sets, as a drawing restriction area, at least some area, of the entire area of a first image obtained by the first obtaining unit 26, that is on the outside of the clothing image in the first image and that is continuous to the first outlines corresponding to the clothing image.

When a plurality of first images is obtained by the first obtaining unit 26; regarding each of the first images that are obtained, the setting unit 30 sets, as a drawing restriction area, at least some area that is on the outside of the clothing image in the first image and that is continuous to the first outlines corresponding to the clothing image.

At the time of generating a synthetic image (described later) by superimposing clothing images onto a photographic subject image, the drawing restriction area points to such an area in the clothing images at lower levels of superimposition and such an area in the photographic subject image in which drawing is restricted.

In the first embodiment, it is assumed that each pixel constituting a clothing image and each pixel constituting a photographic subject image has a drawing restriction flag (sometimes also termed as a mask flag) that indicates restriction on drawing. In the initial state, the drawing restriction flag is disabled. The setting unit 30 enables the drawing restriction flag of a particular pixel so as to set the pixel at that pixel position as a pixel constituting a drawing restriction area.

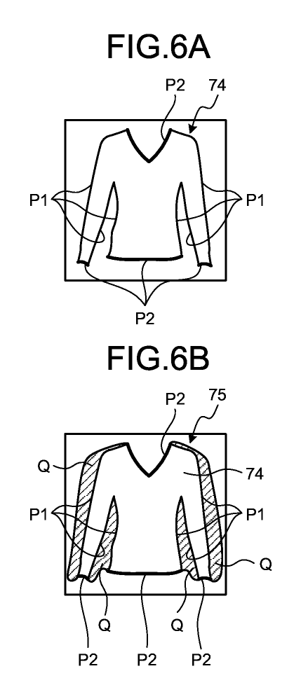

FIGS. 6A and 6B are explanatory diagrams for explaining a drawing restriction area.

For example, assume that the clothing image illustrated in FIG. 6A is a clothing image to be superimposed and has image outline information in the form of the second outlines P2 that correspond to openings and the first outlines P1 other than the openings.

In this case, as illustrated in FIG. 6B, in a first image 75, the setting unit 30 sets, as the drawing restriction area, an area Q that lies on the outside of the clothing image 74 and that is continuous to the first outlines P1.

Herein, as long as the drawing restriction area is on the outside of the clothing image (in FIG. 6A, the clothing image 74) of a first image (in FIG. 6B, the first image 75) and is continuous to the first outlines P1, there is no restriction on the largeness thereof. For example, the largeness of the drawing restriction area can be determined according to the skeleton information which corresponds to the pixel position of each pixel constituting the first outlines P1.

Returning to the explanation with reference to FIG. 1, when the photographic subject image included in a second image is a clothing image, the setting unit 30 can set the drawing restriction area regarding that clothing image too. In this case, the first outlines in that clothing image are extracted by implementing a known method and the drawing restriction area is set in an identical manner to that described above.

Moreover, after the image deforming unit 36 has performed image deformation; the setting unit 30 refers to the post-image-deformation clothing image and the post-image-deformation image outline information and, as the drawing restriction areas, sets such an area in the first image that is on the outside of the deformed clothing image and that is continuous to the changed first outlines.

With respect to the photographic subject image included in a second image obtained by the second obtaining unit 22, the generating unit 32 generates a synthetic image by synthesizing the photographic subject image, from which is removed the area corresponding to the drawing restriction area, and the clothing images.

More specifically, regarding the clothing images to be superimposed on the photographic subject image, the generating unit 32 generates a synthetic image by synthesizing the clothing images, from which is removed the drawing restriction area that is set in the clothing images to be superimposed at corresponding higher levels, and the photographic subject image.

More specifically, on the photographic subject image included in a second image obtained by the second obtaining unit 22, the generating unit 32 superimposes the clothing images, which are included in one or more first images obtained by the first obtaining unit 26, according to the sequence of superimposition obtained by the first obtaining unit 26. At that time, regarding each image (the photographic subject image and the clothing images) on which other images are to be superimposed; the generating unit 32 removes the pixels at the pixel positions corresponding to the drawing restriction area set in the clothing images to be superimposed at corresponding higher levels, and then superimposes the images in order from the lower level toward the higher level. With that, the generating unit 32 generates a synthetic image.

The presentation control unit 34 performs control for presenting the synthetic image on the presenting unit 20.

Given below is the explanation about the image processing performed in the image processing device 12 according to the first embodiment.

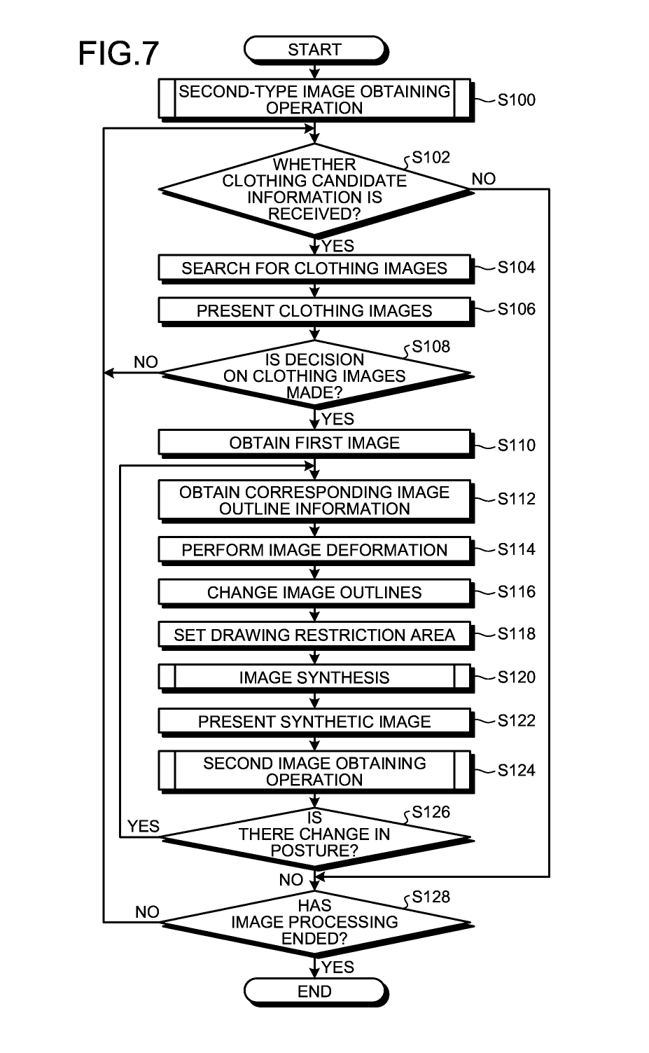

FIG. 7 is a flowchart for explaining a sequence of operations performed during the image processing by the image processing device 12 according to the first embodiment.

Firstly, the second obtaining unit 22 performs a second image obtaining operation (described later in detail) for the purpose of obtaining a second image (Step S100). With that, the second obtaining unit 22 obtains a second image that contains a photographic subject image, which is formed by capturing a photographic subject and on which clothing images are to be superimposed.

Then, the second receiving unit 24 determines whether or not the clothing candidate information has been received from the input unit 16 (Step S102). If the clothing candidate information is not yet received (No at Step S102), the system control proceeds to Step S128. On the other hand, if the clothing candidate information has been received (Yes at Step S102); then the system control proceeds to Step S104.

The first obtaining unit 26 searches the memory unit 18 for the clothing images corresponding to the clothing candidate information received at Step S102 (Step S104) and presents the clothing images on the presenting unit 20 (Step S106).

At Step S104, it is desirable that the first obtaining unit 26 searches the memory unit 18 for the clothing images that correspond not only to the posture information specified in the photographic subject image of the second image received at Step S100 but also to the clothing candidate information received at Step S102.

Then, the second receiving unit 24 determines whether or not the user has operated the input unit 16 and decided on one or more clothing images to be superimposed from the list of clothing images presented on the presenting unit 20 (Step S108). If the decision on clothing images is yet to be made (No at Step S108), then the system control returns to Step S102. Herein, if the decision on clothing images is yet to be made, it points to the case in which the user has operated the input unit 16 and has input a change instruction for changing the clothing images presented on the presenting unit 20.

Then, as the first images to be superimposed, the first obtaining unit 26 obtains the first images that contains the clothing images selected by the user by operating the input unit 16 (Step S110). When a plurality of first images is obtained, the first obtaining unit 26 also obtains information indicating the sequence of superimposition of the clothing images.

Then, from the memory unit 18, the first obtaining unit 26 obtains the image outline information which corresponds to the photographic subject image and which is included in the first images obtained at Step S110 (Step S112).

Subsequently, the first image deforming unit 42 deforms the clothing image included in each first image, which is obtained at Step S110, in such a way that the clothing captured in the clothing image takes the shape of the photographic subject having the posture identified by the posture information that is specified in the photographic subject image of the previously-obtained second image (i.e., the second image obtained at Step S100 or at Step S124 (described later)) (Step S114).

Then, the second image deforming unit 44 changes the image outline information (the second outlines and the first outlines) corresponding to the clothing image, which is included in each first image obtained at Step S108, in such a way that the first outlines and the second outlines of the clothing image take the shape of the photographic subject having the posture identified by the posture information that is specified in the photographic subject image of the previously-obtained second image (i.e., the second image obtained at Step S100 or at Step S124) (Step S116).

Then, the setting unit 30 sets, as the drawing restriction area, at least some area, of the entire area of each first image obtained at Step S110, that is on the outside of the clothing image in that first image and that is continuous to the first outlines corresponding to that clothing image (Step S118).

Subsequently, the generating unit 32 performs a synthesizing operation to generate a synthetic image by synthesizing the clothing images, which are included in the first images obtained at Step S110 and from which is removed the drawing restriction area that is set in the clothing images to be superimposed at respective higher levels, and the photographic subject image from which is removed the drawing restriction area that is set in the clothing images (Step S120).

The presentation control unit 34 performs control for presenting the synthetic image, which is generated as a result of the synthesizing operation performed by the generating unit 32 at Step S120, on the presenting unit 20 (Step S122).

Subsequently, in an identical manner to Step S100, the second obtaining unit 22 obtains a new second image (Step S124). Then, the second obtaining unit 22 determines whether or not there is any change in the posture of the photographic subject, that is, determines whether or not the posture of the photographic subject, which is captured in the photographic subject image included in the second image obtained at Step S124, is different than the posture of the photographic subject that is captured in the second image obtained previously by the second obtaining unit 22 (Step S126). The determination at Step S126 is performed by, for example, determining whether or not the posture information specified in the second image obtained previously by the second obtaining unit 22 is inconsistent with the posture information specified in the second image obtained this time by the second obtaining unit 22.

If it is determined that there is a change in the posture of the photographic subject (Yes at Step S126), then the system control returns to Step S112. Alternatively, if it is determined that there is a change in the posture of the photographic subject (Yes at Step S126), then the system control may also return to Step S102.

On the other hand, if it is determined that there is no change in the posture of the photographic subject (No at Step S126), then the system control proceeds to Step S128. Then, the image processing device 12 determines whether or not the image processing is ended (Step S128). The determination at Step S128 is performed, for example, by determining whether or not a signal indicating the end of image processing is received from the input unit 16.

If it is determined that the image processing is not ended (No at Step S128), then the system control returns to Step S100. On the other hand, if it is determined that the image processing is ended (Yes at Step S128), then that marks the end of the present routine.

Given below is the explanation of the second image obtaining operation performed at Step S100 and Step S124 (see FIG. 7).

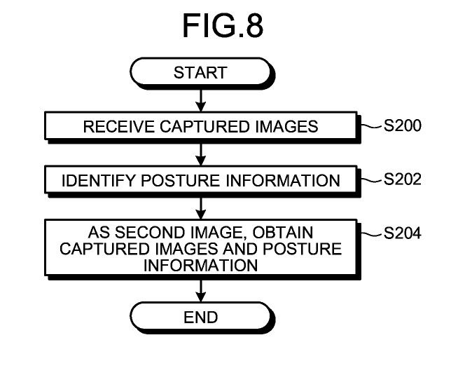

FIG. 8 is a flowchart for explaining the second image obtaining operation.

Firstly, the first receiving unit 38 of the second obtaining unit 22 receives captured images from the imaging unit 14 (Step S200). For example, the first receiving unit 38 obtains, as captured images, a color image and a depth image of a photographic subject from the imaging unit 14 (Step S200).

Then, the identifying unit 40 identifies the posture information of the photographic subject from the color image and the depth image received at Step S200 (Step S202).

Subsequently, the second obtaining unit 22 obtains, as a second image, the color image and the depth image received at Step S200 and the posture information identified at Step S202 (Step S204). That marks the end of the present routine.

Given below is the explanation of the synthesizing operation performed at Step S120 (see FIG. 7).

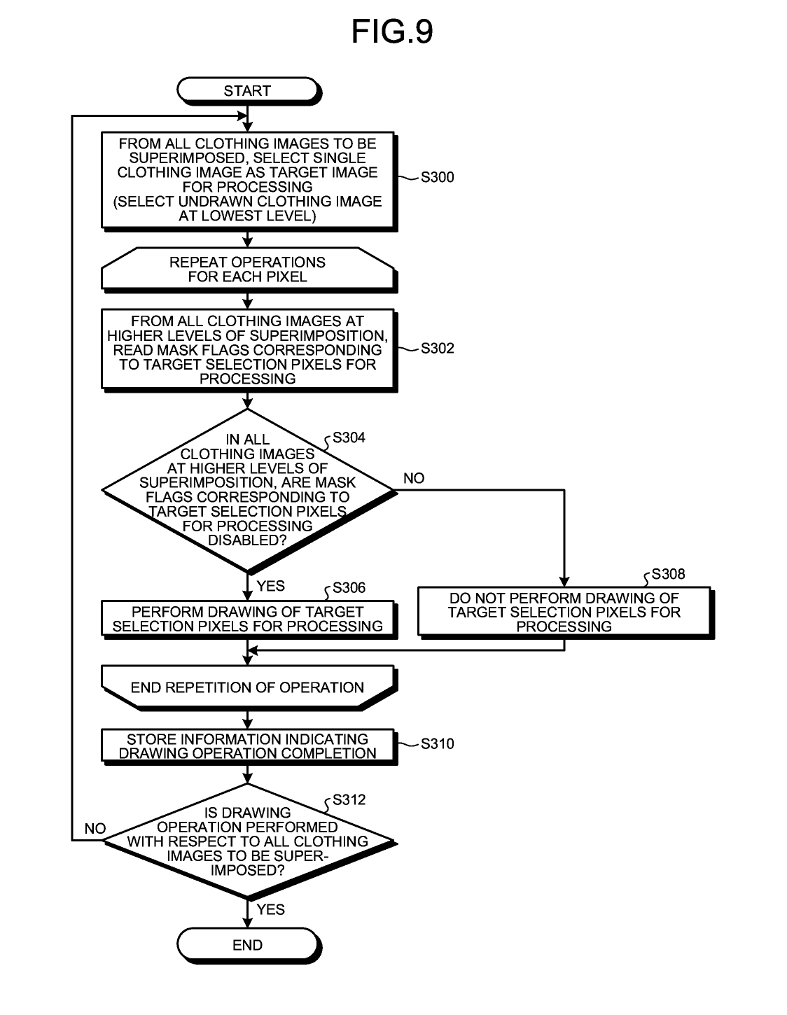

FIG. 9 is a flowchart for explaining the synthesizing operation performed by the generating unit 32.

Firstly, from among the clothing images included in a plurality of first images obtained by the first obtaining unit 26 (i.e., from all clothing images that are to be superimposed), the generating unit 32 selects a single clothing image as the target image for processing (Step S300). At that time, from among undrawn clothing images on which a drawing operation is not yet performed; the generating unit 32 selects the clothing image that is to be superimposed at the lowest level.

Meanwhile, in a memory (not illustrated), the first obtaining unit 26 stores the identification information of the first images that are obtained for the purpose of superimposition at Step S110. Then, every time the drawing operation (described later) is performed; the generating unit 32 stores, in the memory, the information indicating drawing operation completion in a corresponding manner to the identification information of the clothing image for which the drawing operation was performed from among the identification information of the clothing images of the first images obtained at Step S110. Then, at Step S300, from among the clothing images that do not have the information indicating drawing operation completion associated thereto, the generating unit 32 selects the clothing image that is ranked lowest in the sequence of superimposition as the target image for processing.

Then, the generating unit 32 sequentially selects the pixels constituting the clothing image, which has been selected as the target image for processing, as target selection pixels for processing; and performs operations from Step S302 to Step S306 in a repeated manner.

Regarding the target selection pixels for processing that constitute the clothing image which has been selected as the target image for processing at Step S300; the generating unit 32 reads, from all clothing images at higher levels of superimposition, the mask flags of the pixels positioned at the pixel positions of the target selection pixels for processing (Step S302). Herein, all clothing images at higher levels of superimposition point to all clothing images to be superimposed at higher levels than the target image for processing that has been selected at Step S300. The clothing images to be superimposed at higher levels can be determined by referring to superimposition information corresponding to each clothing image obtained at Step S110.

Then, the generating unit 32 determines whether or not, in the clothing images at higher levels, all mask flags, which are read at Step S302, of the pixels at the pixel positions of the target selection pixels for processing are disabled (Step S304).

If all mask flags are disabled (Yes at Step S304), then the generating unit 32 performs drawing with the pixel values of the target selection pixels for processing, which constitute the target clothing image for processing selected at Step S300, as the pixel values of the pixels at the pixel positions (Step S306).

On the other hand, if all mask flags are not disabled (No at Step S304), then the generating unit 32 does not perform drawing with the pixel values of the target selection pixels for processing, which constitute the target clothing image for processing selected at Step S300, as the pixel values of the pixels at the pixel positions (Step S308).

By repeating the operations from Step S302 to Step S306, regarding the pixel position of each pixel constituting the clothing image that is selected as the target image for processing at Step S300, the generating unit 32 does not perform pixel drawing at that pixel position if the clothing images to be superimposed at higher levels have the drawing restriction area set therein, but performs pixel drawing at that pixel position if the clothing images to be superimposed at higher levels do not have the drawing restriction area set therein.

Subsequently, the generating unit 32 stores, in the memory (not illustrated), the information indicating drawing operation completion in a corresponding manner to the identification information of the clothing image that was selected as the target image for processing in the operations from Step S302 to Step S308 (Step S310).

Then, the generating unit 32 determines whether or not the drawing operation is performed with respect to the clothing image included in each first image that is obtained by the first obtaining unit 26 as the image to be superimposed (Step S312). If the drawing operation is not yet performed with respect to each clothing image (No at Step S312), then the system control returns to Step S300. On the other hand, once the drawing operation is performed with respect to all clothing images (Yes at Step S312), then that marks the end of the synthesizing operation.

As a result of performing the operations from Step S300 to Step S312; a synthesizing image is generated by synthesizing the clothing images, each of which is included in a first image obtained by the first obtaining unit 26 and from each of which is removed the drawing restriction area that is set in the clothing images superimposed at corresponding higher levels, with the photographic subject image, from which is removed the drawing restriction area that is set in the clothing images.

As described above, in the image processing device 12 according to the first embodiment, the first obtaining unit 26 obtains the first images each including a clothing image to be superimposed. The second obtaining unit 22 obtains a second image that contains a photographic subject image on which the clothing images are to be superimposed. The third obtaining unit 28 obtains the second outlines that correspond to openings of the clothing in the image outline and first outlines that are the image outlines other than the second outlines. Then, the setting unit 30 sets, as the drawing restriction area, at least some area that is on the outside of the clothing image in a first image and that is continuous to the first outlines. The generating unit 32 generates a synthetic image by synthesizing the photographic subject image, from which is removed the area corresponding to the drawing restriction area, with the clothing images, from each of which is removed the drawing restriction area that is set in the clothing images to be superimposed at corresponding higher levels.

In this way, in the image processing device 12 according to the first embodiment, prior to generating a synthetic image by synthesizing a photographic subject image with one or more clothing images, the area continuous to the first outlines in the clothing images is set as the drawing restriction area and is removed from the photographic subject image and the clothing images at lower levels. Then, the photographic subject image, from which the drawing restriction area is removed, is synthesized with the clothing images, from which the drawing restriction area is removed.

As a result, even at a low processing load, the image processing device 12 can generate a synthetic image having a natural look.

Moreover, even in the case when the posture of the photographic subject changes frequently and the synthetic images are generated in succession, the drawing restriction area is removed prior to synthesizing the photographic subject image with the clothing images. As a result, it becomes possible to generate the synthetic images at a low processing load.

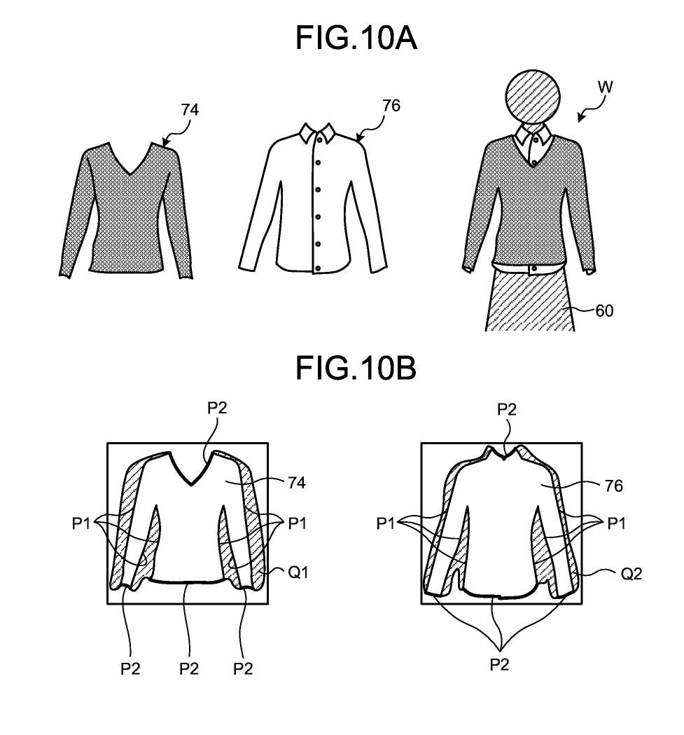

FIGS. 10A and 10B are schematic diagrams illustrating the generation of a synthetic image in the image processing device 12 according to the first embodiment.

As illustrated in FIG. 10A, assume that a clothing image 76 and the clothing image 74 are superimposed in that order on a photographic subject image 61. Then, as illustrated in FIG. 10B, in the clothing image 76, the second outlines P2 and the first outlines P1 are set, and the area continuous to the first outlines P1 is set as a drawing restriction area Q2. Similarly, in the clothing image 74, the second outlines P2 and the first outlines P1 are set, and the area continuous to the first outlines P1 is set as a drawing restriction area Q1.

In this case, in the image processing device 12, the drawing restriction area Q2 of the clothing image 76, which is superimposed at a higher level than the image of the photographic subject 60, is removed from the image of the photographic subject 60. Similarly, in the image processing device 12, the drawing restriction area Q1 of the clothing image 74, which is superimposed at a higher level than the image of the photographic subject 60, is removed from the image of the photographic subject 60. Moreover, in the image processing device 12, the drawing restriction area Q2 of the clothing image 74, which is superimposed at a higher level than the clothing image 76, is removed from the clothing image 76 too. Since there is no clothing image that is superimposed at a higher level than the clothing image 74, no drawing restriction area is removed therefrom.

Subsequently, the image processing device 12 generates the synthetic image W in which the clothing image 76, from which is removed the drawing restriction area Q1, and the clothing image 74 are superimposed in that order on the image of the photographic subject 60, from which are removed the drawing restriction areas Q1 and Q2.

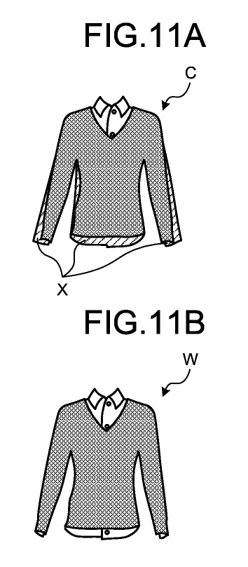

FIGS. 11A and 11B are schematic diagrams illustrating a contrast between a conventional synthetic image and the synthetic image generated by the image processing device 12 according to the first embodiment.

As illustrated in FIG. 11A, conventionally, a synthetic image C is generated in which a plurality of clothing images is superimposed without removing the drawing restriction area therefrom. For that reason, a clothing image superimposed at the lower level protrudes from a clothing image superimposed at the higher level. As a result, protruding areas X are formed in the synthetic image C.

In contrast, in the image processing device 12 according to the first embodiment, as illustrated in FIG. 11B, the drawing restriction area is removed before superimposing a plurality of clothing images to generate the synthetic image W. For that reason, a clothing image superimposed at the lower level does not protrude from a clothing image superimposed at the higher level. As a result, the synthetic image W having a natural look is generated.

Moreover, prior to generating a synthetic image, the area set as the drawing restriction area in the clothing images at higher levels is removed from the photographic subject image as well as from the clothing images at lower levels. As a result, it becomes possible to generate the synthetic images at a low processing load.

Hence, in the image processing device 12, synthetic images having a natural look can be generated at a low processing load.

### Second Embodiment

In the first embodiment, the explanation is given for a case in which the sequence of superimposition is set for the clothing images, and the generating unit 32 performs drawing restriction area removal and image synthesis according to the sequence of superimposition. However, alternatively, it is also possible to divide each clothing image on the basis of the clothing parts constituting that clothing image, and the sequence of superimposition can be further set according to the clothing parts. For example, if a shirt is captured in a clothing image, then the clothing parts thereof include the sleeves and the collar.

FIG. 1 is a schematic diagram illustrating an image processing system 10B according to a second embodiment.

The image processing system 10B includes an image processing device 12B, the imaging unit 14, the input unit 16, a memory unit 18B, and the presenting unit 20. The image processing device 12B includes the second obtaining unit 22, the second receiving unit 24, the first obtaining unit 26, the third obtaining unit 28, a setting unit 30B, a generating unit 32B, the presentation control unit 34, and the image deforming unit 36.

As compared to the image processing system 10, the image processing system 10B differs in the way that the memory unit 18 is replaced with the memory unit 18B and the image processing device 12 is replaced with the image processing device 12B. Moreover, as compared to the image processing device 12, the image processing device 12B differs in the way that the setting unit 30 is replaced with the setting unit 30B and the generating unit 32 is replaced with the generating unit 32B.

The memory unit 18B is used to store, in advance, first images, each containing a clothing image to be superimposed on a photographic subject image, and image outline information. In the second embodiment, the explanation is given for a case in which the memory unit 18B is used to store a table containing the first images.

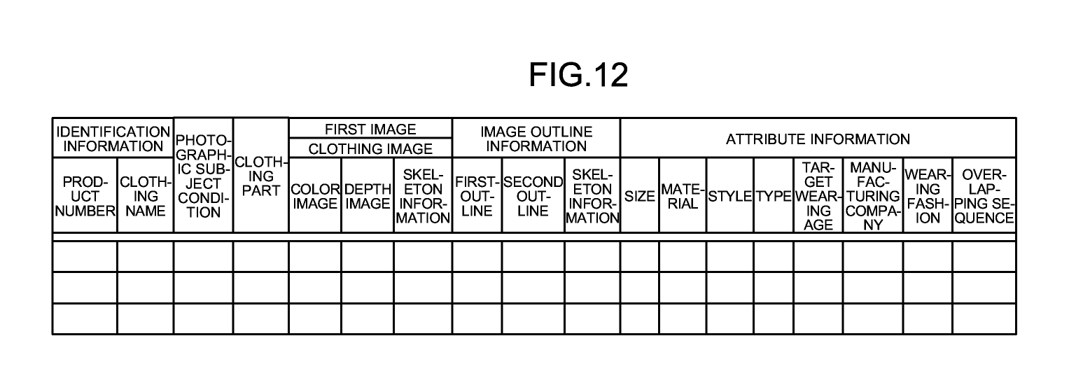

FIG. 12 is a schematic diagram illustrating an exemplary data structure of the table containing the first images.

As illustrated in FIG. 12, the table containing the first images is used to store identification information, photographic subject conditions, clothing parts, the first images, the image outline information, and attribute information in a corresponding manner. Thus, as compared to the memory unit 18, the memory unit 18B differs in the way that the clothing parts are additionally stored therein.

The clothing parts point to the parts of an article of clothing when a clothing image, which is identified by the corresponding identification information, is divided into a plurality of parts. Thus, if a shirt is captured in a clothing image; then the clothing parts include, for example, the sleeves and the collar.

In the table illustrated in FIG. 12; the clothing image, the image outline information, and the attribute information is determined for each clothing part. The identification information is determined for each clothing image. For that reason, in the table stored in the memory unit 18B, the following information is held in a corresponding manner to the identification information for identifying clothing images: one or more clothing parts; the clothing image corresponding to each clothing part; the image outline information; and the attribute information. The clothing parts in a single clothing image can be identified because they are associated to the same identification information.

Meanwhile, the second obtaining unit 22, the second receiving unit 24, the first obtaining unit 26, the third obtaining unit 28, the presentation control unit 34, and the image deforming unit 36 perform identical operations to the operations described in the first embodiment.

The setting unit 30B performs an identical setting operation to the setting operation performed by the setting unit 30 according to the first embodiment. However, the setting unit 30B sets a drawing restriction area for each clothing part included in a clothing image that is obtained by the first obtaining unit 26 and deformed by the image deforming unit 36. The generating unit 32B performs identical operations to the operations performed by the generating unit 32 according to the first embodiment. However, the generating unit 32B performs the synthesizing operation according to the sequence of superimposition corresponding to the clothing parts.

In this way, each clothing image is divided into clothing parts that constitute the clothing image, and the sequence of superimposition is further set according to the clothing parts. With that, for example, a synthetic image can be generated in such a way that a blouse, which is captured in a clothing image to be superimposed, has its sleeves brought out of a sweater, which is captured in another clothing image to be superimposed on the clothing image of blouse.

### Third Embodiment

In the first embodiment, for each first image, the setting unit 30 sets a drawing restriction area in the area continuous to the first outlines of the clothing image. In the second embodiment, a clothing image is divided into a plurality of clothing parts, and the sequence of superimposition is set according to the clothing parts.

In addition, it is also possible to set a superimposition rule for the clothing parts and to generate a synthetic image based on the superimposition rule.

FIG. 1 is a schematic diagram illustrating an image processing system 10C according to a third embodiment.

The image processing system 10C includes an image processing device 12C, the imaging unit 14, the input unit 16, a memory unit 18C, and the presenting unit 20. The image processing device 12C includes the second obtaining unit 22, the second receiving unit 24, the first obtaining unit 26, the third obtaining unit 28, the setting unit 30B, a generating unit 32C, the presentation control unit 34, and the image deforming unit 36.

As compared to the image processing system 10, the image processing system 10B differs in the way that the memory unit 18 is replaced with the memory unit 18C and the image processing device 12 is replaced with the image processing device 12C. Moreover, as compared to the image processing device 12, the image processing device 12C differs in the way that the setting unit 30 is replaced with the setting unit 30B and the generating unit 32 is replaced with the generating unit 32C. Herein, the setting unit 30B is identical to that explained in the second embodiment.

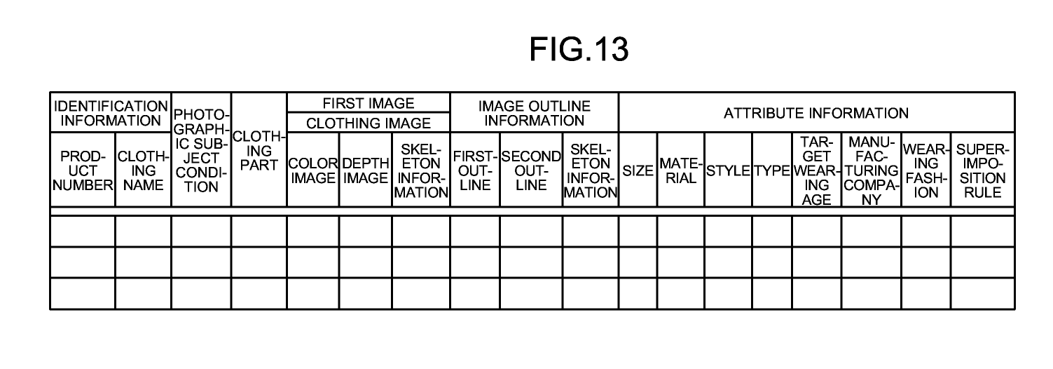

The memory unit 18C is used to store a table illustrated in FIG. 13 instead of the table containing the first images as illustrated in FIG. 12. FIG. 13 is a schematic diagram illustrating a data structure of the table that is different than the table containing the first images as illustrated in FIG. 12.

As illustrated in FIG. 13, the table containing the first images is used to store, for example, identification information, photographic subject condition, clothing parts, the first images, the image outline information, and attribute information in a corresponding manner. Moreover, as compared to the data structure of the tables illustrated in FIGS. 3 and 12, the table illustrated in FIG. 13 differs in the way that the attribute information further contains a superimposition rule.

Regarding each clothing part, the corresponding superimposition rule is set to indicate whether or not to enable the drawing restriction area with respect to the other clothing parts or the other types of clothing images. For example, consider the sleeves of a shirt as the clothing part. In that case, for example, regarding the clothing part “sleeves”, the superimposition rule is set in advance indicating that a drawing restriction flag is disabled for a clothing image or a clothing part of the type “skirt”.

At the time of synthesizing clothing images, the generating unit 32C refers to the superimposition rule. If the superimposition rule for the target clothing part for processing (for example, “sleeves” of a shirt) indicates that the drawing restriction flag is disabled for a clothing image or a clothing part of the type “skirt”; then, even in the case of superimposing a clothing image of the type “skirt” on a clothing image of the type “shirt” having the clothing part “sleeves”, the generating unit 32C treats the drawing restriction flag of the clothing image of the type “skirt”, which is superimposed on the clothing part “sleeves”, as disabled.

In this way, by additionally setting the superimposition rule, in the case of generating a synthetic image by superimposing, for example, a clothing image of the type “blouse” and a clothing image of the type “skirt” in that order; the clothing part “sleeves” in the clothing image of the type “blouse” is not affected by the drawing restriction area in the clothing image of the type “skirt”. On the other hand, regarding the clothing parts other than the clothing part “sleeves” in the clothing image of the type “blouse”, the area corresponding to the drawing restriction area in the clothing image of the type “skirt” is removed. That is followed by the generation of the synthetic image.

For that reason, it becomes possible to provide a synthetic image having a more natural look.

### Fourth Embodiment

In a fourth embodiment, depending on the degree of deformation easiness of the clothing identified in a clothing image, the extent of deformation is adjusted.

FIG. 1 is a schematic diagram illustrating an image processing system 10D according to the fourth embodiment.

The image processing system 10D includes an image processing device 12D, the imaging unit 14, the input unit 16, a memory unit 18D, and the presenting unit 20. The image processing device 12D includes the second obtaining unit 22, the second receiving unit 24, a first obtaining unit 26D, the third obtaining unit 28, the setting unit 30, the generating unit 32, the presentation control unit 34, and an image deforming unit 36D.

As compared to the image processing system 10, the image processing system 10D differs in the way that the memory unit 18 is replaced with the memory unit 18D and the image processing device 12 is replaced with the image processing device 12D. Moreover, as compared to the image processing device 12, the image processing device 12D differs in the way that the image deforming unit 36 is replaced with the image deforming unit 36D and the first obtaining unit 26 is replaced with the first obtaining unit 26D.

The memory unit 18D is used to store, in advance, first images, each of which contains a clothing image that is to be superimposed on a photographic subject image, and image outline information. In the fourth embodiment, the explanation is given for a case in which the memory unit 18D is used to store a table containing the first images.

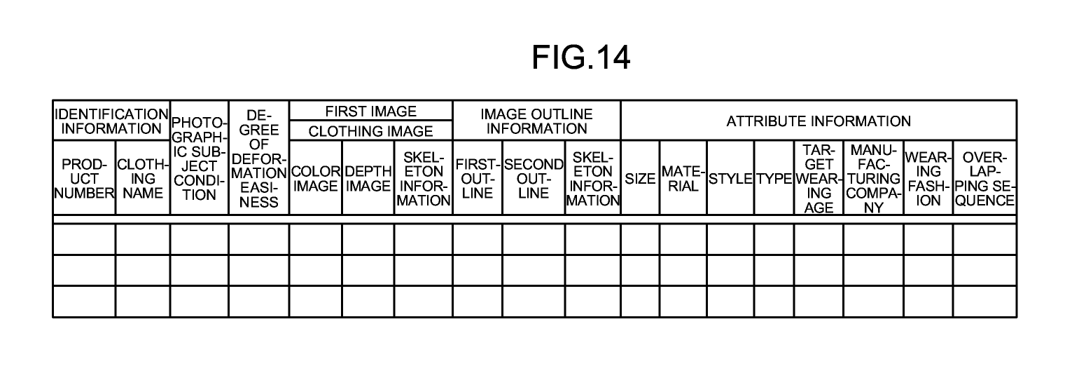

FIG. 14 is a schematic diagram illustrating an exemplary data structure of the table containing the first images.

As illustrated in FIG. 14, the table containing the first images is used to store identification information, photographic subject conditions, degree of deformation easiness, the first images, the image outline information, and attribute information in a corresponding manner. As compared to the memory unit 18, the memory unit 18D differs in the way that the degree of deformation easiness is additionally stored therein.

Herein, the degree of deformation easiness indicates the degree of easiness in changing the shape of clothing identified in the corresponding clothing image. Thus, higher the degree of deformation easiness, easier it is for the clothing to change the shape. In contrast, lower the degree of deformation easiness, the more difficult it is for the clothing to change the shape.

The first obtaining unit 26D obtains a plurality of first images; obtains the sequence of superimposition of the clothing images each included in one of the first images; and obtains the degree of deformation easiness of the clothing in each clothing image. The first obtaining unit 26D reads, from the memory unit 18D, the sequence of superimposition and the degree of deformation easiness regarding the clothing in the clothing images that are to be superimposed according to the selection performed by the user by operating the input unit 16.

In an identical manner to the image deforming unit 36 according to the first embodiment, the clothing images included in the first images obtained by the first obtaining unit 26D and changes the first outlines corresponding to those clothing images in such a way that the clothing captured in the clothing images takes the shape of the photographic subject having the posture identified by the posture information specified in the second image that is obtained by the second obtaining unit 22.

Moreover, in the fourth embodiment, the image deforming unit 36D deforms the clothing images included in the first images obtained by the first obtaining unit 26D and changes the first outlines corresponding to those clothing images in such a way that the image outlines of the clothing image having the lowest degree of deformation easiness are positioned on the outermost side and the clothing images having higher degrees of deformation easiness are respectively positioned on the inner side of the outermost image outlines.

More specifically, the image deforming unit 36D includes a first image deforming unit 42D and a second image deforming unit 44D. The first image deforming unit 42D deforms the clothing images included in the first images in such a way that the clothing images take the shape of the photographic subject having the posture identified by the posture information that is obtained by the second obtaining unit 22.

Moreover, in the fourth embodiment, the first image deforming unit 42D deforms the clothing images, which are included in the first images obtained by the first obtaining unit 26D, in such a way that the image outlines of the clothing image having the lowest degree of deformation easiness are positioned on the outermost side and the clothing images having higher degrees of deformation easiness are respectively positioned on the inner side of the outermost image outlines.

The second image deforming unit 44D changes the image outlines (the second outlines and the first outlines) corresponding to the clothing images, which are included in the first images, in such a way that the clothing images take the shape of the photographic subject having the posture identified by the posture information that is obtained by the second obtaining unit 22.

Moreover, in the fourth embodiment, the second image deforming unit 44D changes the image outlines (the second outlines and the first outlines) corresponding to the clothing images, which are included in the first images obtained by the first obtaining unit 26D, in such a way that the image outlines of the clothing image having the lowest degree of deformation easiness are positioned on the outermost side and the clothing images having higher degrees of deformation easiness are respectively positioned on the inner side of the outermost image outlines. Herein, the method of changing the image outlines is identical to the method implemented in the first embodiment.

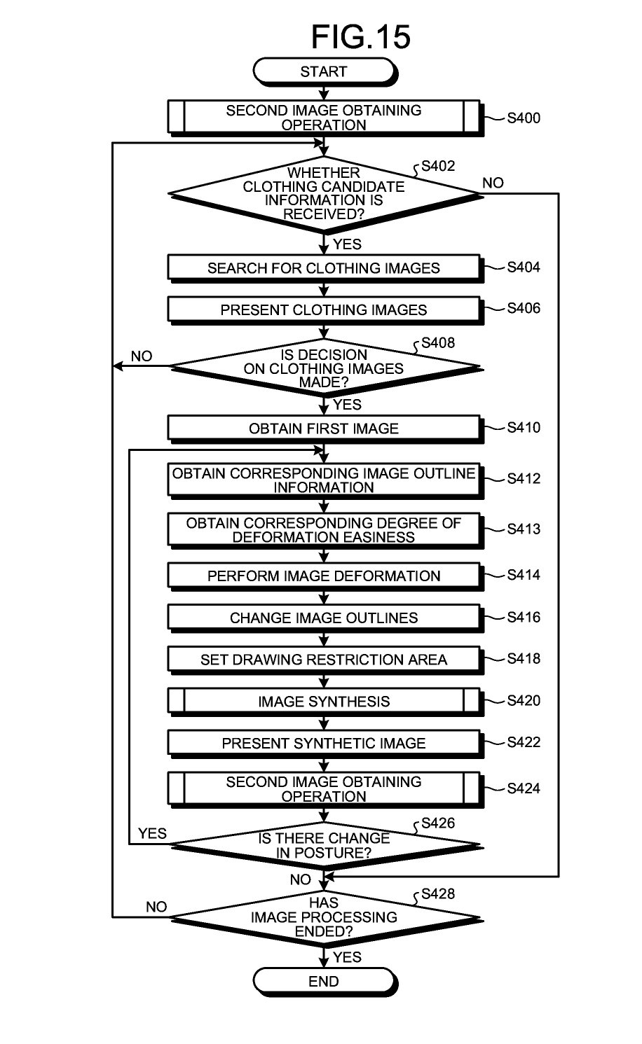

Given below is the explanation regarding the image processing performed in the image processing device 12D according to the fourth embodiment. FIG. 15 is a flowchart for explaining a sequence of operations performed during the image processing by the image processing device 12D according to the fourth embodiment.

In the image processing device 12D, the operations from Step S400 to Step S412 are identical to the operations performed from Step S100 to Step S112 (see FIG. 7) during the image processing according to the first embodiment.

As a result of performing the operations from Step S400 to Step S412, a second image is obtained that contains a photographic subject image; one or more first images are obtained each of which contains a clothing image to be superimposed; and image outline information (the second outlines and the first outlines) corresponding to each clothing image is obtained.

Then, the first obtaining unit 26D obtains the degree of deformation easiness corresponding to each clothing image to be superimposed, which is obtained as a result of performing the operations from Step S400 to Step S412 (Step S413).

Subsequently, the first image deforming unit 42D deforms the clothing image included in each of the first images in such a way that the clothing in the clothing images, which are included in the first images obtained at Step S410, takes the shape of the photographic subject having the posture identified by the posture information that is specified in the previously-obtained second image (i.e., the second image obtained at Step S400 or at Step S424 (described later). Then, according to the degrees of deformation easiness obtained at Step S413, the first image deforming unit 42D deforms the clothing image included in each of the first images in such a way that the image outlines of the clothing image having the lowest degree of deformation easiness are positioned on the outermost side and the clothing images having higher degrees of deformation easiness are respectively positioned on the inner side of the outermost image outlines (Step S414).

Subsequently, the second image deforming unit 44D changes the first outlines corresponding to the clothing images, which are included in the first images obtained at Step S410, in such a way that the first outlines and the second outlines of the clothing image included in each first image take the shape of the photographic subject having the posture identified by the posture information that is specified in the second image obtained at Step S400. Moreover, the second image deforming unit 44D changes the image outlines (the second outlines and the first outlines) corresponding to the clothing images, which are included in the first images obtained at Step S410, in such a way that the image outlines of the clothing image having the lowest degree of deformation easiness are positioned on the outermost side and the clothing images having higher degrees of deformation easiness are respectively positioned on the inner side of the outermost image outlines (Step S416).

Then, the setting unit 30 sets, as a drawing restriction area, at least some area, of the entire area of each first image obtained at Step S410, that is on the outside of the clothing image in that first image and that is continuous to the first outlines corresponding to that clothing image (Step S418).

Subsequently, the generating unit 32 performs a synthesizing operation to generate a synthetic image by synthesizing the clothing images, which are included in the first images obtained at Step S410 and from which is removed the drawing restriction area that is set in the clothing images to be superimposed at respective higher levels, and the photographic subject image from which is removed the drawing restriction area that is set in the clothing images (Step S420). The synthesizing operation performed at Step S420 is identical to the synthesizing operation performed in the first embodiment (see Step S120 in FIG. 7).

Then, the presentation control unit 34 performs control for presenting the synthetic image, which is generated as a result of the synthesizing operation performed by the generating unit 32 at Step S420, on the presenting unit 20 (Step S422).

Subsequently, in an identical manner to Step S400, the second obtaining unit 22 obtains a new second image (Step S424). Then, the second obtaining unit 22 determines whether or not there is any change in the posture of the photographic subject, that is, determines whether or not the posture of the photographic subject, which is captured in the photographic subject image included in the second image obtained at Step S424, is different than the posture of the photographic subject that is captured in the second image obtained previously by the second obtaining unit 22 (Step S426).

If it is determined that there is a change in the posture of the photographic subject (Yes at Step S426), then the system control returns to Step S412. Alternatively, if it is determined that there is a change in the posture of the photographic subject (Yes at Step S426), then the system control may also return to Step S402.

On the other hand, if it is determined that there is no change in the posture of the photographic subject (No at Step S426), then the system control proceeds to Step S428. Then, in an identical manner to Step S128 described above, the image processing device 12D determines whether or not the image processing is ended (Step S428).

If it is determined that the image processing is not ended (No at Step S428), then the system control returns to Step S400. On the other hand, if it is determined that the image processing is ended (Yes at Step S428), then that marks the end of the present routine.

In this way, the image deforming unit 36D deforms the clothing images according to the degrees of deformation easiness. As a result, in addition to the effect achieved according to the first embodiment, it becomes possible to provide synthetic images having a more natural look.

### Fifth Embodiment

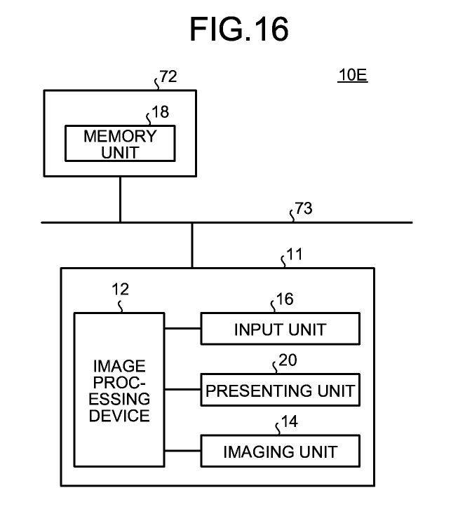

FIG. 16 is a schematic diagram illustrating an image processing system 10E. In the image processing system 10E, a memory device 72 and a processing device 11 are connected via a communication line 73.

The memory device 72 is a publicly known personal computer that includes the memory unit 18 according to the first embodiment. The processing device 11 includes the image processing device 12, the imaging unit 14, the input unit 16, and the presenting unit 20 according to the first embodiment. Herein, the constituent elements identical to those according to the first embodiment are referred to by the same reference numerals, and the explanation thereof is not repeated. The communication line 73 is a wire communication line or a wireless communication line.

As illustrated in FIG. 16, with the configuration in which the memory unit 18 is disposed in the memory device 72 that is connected to the processing device 11 (the image processing device 12) via the communication line 73, it becomes possible to access the same memory unit 18 from a plurality of processing devices 11 (a plurality of image processing devices 12). Moreover, it becomes possible to perform uniform management of the data stored in the memory unit 18.

The processing device 11 can be installed at any arbitrary location. For example, the processing device 11 can be installed at a place, such as a shop, at which the user can view the synthetic images. Moreover, the functions of the processing device 11 can also be provided in a publicly known handheld device.

### Sixth Embodiment

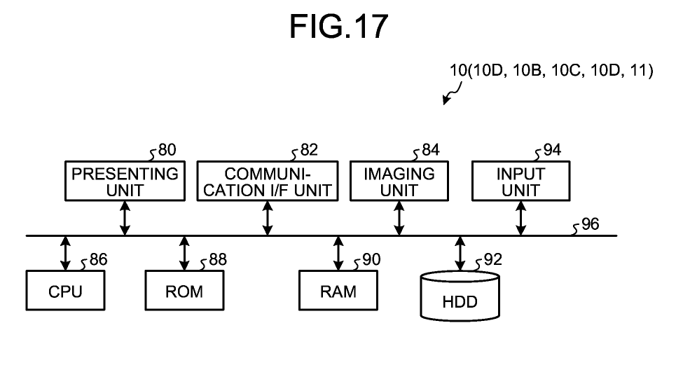

Given below is the explanation regarding a hardware configuration of the image processing device 12 according to the first embodiment, the image processing device 12B according to the second embodiment, the image processing device 12C according to the third embodiment, the image processing device 12D according to the fourth embodiment, and the image processing device 12 according to the fifth embodiment. FIG. 17 is a block diagram illustrating an exemplary hardware configuration of the image processing devices 12 to 12D according to the first to fifth embodiments.

The image processing devices 12 to 12D according to the first to fifth embodiments have the hardware configuration of a commonly used computer in which a presenting unit 80, a communication I/F unit 82, an imaging unit 84, an input unit 94, a CPU 86, a ROM 88, a RAM 90, and a hard disk drive (HDD) 92 are mutually connected by a bus 96.

The CPU 86 is a processor that controls the overall operations of the image processing devices 12 to 12D. The RAM 90 is used to store data that is required during various operations performed by the CPU 86. The ROM 88 is used to store computer programs that implement various operations performed by the CPU 86. The HDD 92 is used to store data that is stored in each memory unit 18. The communication I/F unit 82 is connected to an external device or an external terminal via a communication line and functions as an interface for sending data to and receiving data from the external device or the external terminal. The presenting unit 80 corresponds to the presenting unit 20 described above. The imaging unit 84 corresponds to the imaging unit 14 described above. The input unit 94 corresponds to the input unit 16 described above.

The computer programs used for implementing the various operations in the image processing devices 12 to 12D according to the first to fifth embodiments are stored in advance in the ROM 88.

Alternatively, the computer programs used for implementing the various operations in the image processing devices 12 to 12D according to the first to fifth embodiments can be recorded in the form of installable or executable files in a computer-readable recording medium such as a compact disk read only memory (CD-ROM), a flexible disk (FD), a compact disk readable (CD-R), or a digital versatile disk (DVD).

Still alternatively, the computer programs used for implementing the various operations in the image processing devices 12 to 12D according to the first to fifth embodiments can be saved as downloadable files on a computer connected to the Internet or can be made available for distribution through a network such as the Internet.

Meanwhile, the computer programs used for implementing the various operations in the image processing devices 12 to 12D according to the first to fifth embodiments are run such that each of the abovementioned constituent elements is generated in a main memory device.

The variety of information stored in the HDD 92, that is, the variety of information stored in the memory unit 18 can also be stored in an external device (such as a server). In that case, the configuration can be such that the external device and the CPU 86 are connected via a network or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a first obtaining unit configured to obtain a first image which contains a clothing image to be superimposed;
a second obtaining unit configured to obtain a second image which contains a photographic subject image on which the clothing image is to be superimposed;
a third obtaining unit configured to obtain, of an outline of the clothing image, a first outline that is an outline other than openings formed in clothing;
a setting unit configured to set, as a drawing restriction area, at least some area that is on the outside of the clothing image in the first image and that is continuous to the first outline; and
a generating unit configured to generate a synthetic image by synthesizing the photographic subject image, from which is removed an area corresponding to the drawing restriction area, with the clothing image.

2. The device according to claim 1, wherein
the second image includes posture information regarding a photographic subject captured in the photographic subject image,
the image processing device further comprises an image deforming unit configured to deform the clothing image included in the first image and change the first outline corresponding to the clothing image in such a way that clothing captured in the clothing image takes a shape of the photographic subject having a posture identified by the posture information,
the setting unit sets, as the drawing restriction area, at least some area that is on the outside of the deformed clothing image in the first image and that is continuous to the changed first outline, and
the generating unit generates the synthetic image by synthesizing the photographic subject image, from which is removed an area corresponding to the drawing restriction area, with the deformed clothing image.

3. The device according to claim 2, wherein, from a memory unit configured to store therein the clothing image in a corresponding manner to the posture information, the first obtaining unit obtains the first image that contains the clothing image which is consistent with or is closest to the posture information specified in the second image.

4. The device according to claim 1, wherein
the first obtaining unit obtains a plurality of the first images and a sequence of superimposition of a plurality of the clothing images included the plurality of first images,
the third obtaining unit obtains the first outline of each of the plurality of clothing images,
for each of the plurality of first images, the setting unit sets, as the drawing restriction area, at least some area that is on the outside of the clothing image in the first image and that is continuous to the first outline, and
the generating unit generates the synthetic image by synthesizing the photographic subject image, from which is removed an area corresponding to the drawing restriction area set in the plurality of clothing images, with the plurality of clothing images, from each of which is removed the drawing restriction area set in the clothing images that are superimposed at corresponding higher levels according to the sequence of superimposition.

5. The device according to claim 1, wherein
the first obtaining unit obtains a plurality of the first images and a sequence of superimposition of a plurality of clothing parts which are obtained by dividing a plurality of the clothing images included in the plurality of first images,
the third obtaining unit obtains the first outline of each of the plurality of clothing images,
for each of the plurality of first images, the setting unit sets, as the drawing restriction area, at least some area that is on the outside of the clothing image in the first image and that is continuous to the first outline, and
the generating unit generates the synthetic image by synthesizing, according to the sequence of superimposition, the photographic subject image, from which is removed an area corresponding to the drawing restriction area set in the plurality of clothing images, with the plurality of clothing parts, from each of which is removed the drawing restriction area set in the clothing parts that are superimposed at corresponding higher levels according to the sequence of superimposition.

6. The device according to claim 2, wherein
the first obtaining unit obtains a plurality of the first images, a sequence of superimposition of a plurality of the clothing images included in the plurality of first images, and degrees of deformation easiness of clothing captured in the clothing images,
the third obtaining unit obtains the first outline of each of the plurality of clothing images, and
the image deforming unit deforms the clothing images included in the first images and changes the first outlines corresponding to the clothing images in such a way that clothing captured in the clothing images takes a shape of the photographic subject having the posture identified by the posture information and in such a way that the image outline of the clothing image having the lowest degree of deformation easiness is positioned on the outermost side and the image outlines of the clothing images having higher degrees of deformation easiness are respectively positioned on the inner side of the outermost image outline.

7. The device according to claim 1, further comprising a memory unit configured to store therein in advance the posture information, the first image containing the clothing image, and the first outline in a corresponding manner.

8. The device according to claim 1, further comprising a presentation controller configured to present the synthetic image on a presenting unit.

9. The device according to claim 8, further comprising the presenting unit.

10. An image processing method comprising:
obtaining a first image which contains a clothing image to be superimposed;
obtaining a second image which contains a photographic subject image on which the clothing image is to be superimposed;
obtaining, of an image outline of the clothing image, a first outline that is the image outline other than openings formed in clothing;
setting, as a drawing restriction area, at least some area that is on the outside of the clothing image in the first image and that is continuous to the first outline; and
generating a synthetic image by synthesizing the photographic subject image, from which is removed an area corresponding to the drawing restriction area, with the clothing image.

11. A computer program product comprising a computer readable medium including programmed instructions of an image processing program, wherein the instructions, when executed by a computer, cause the computer to perform:
obtaining a second image which contains a photographic subject image on which the clothing image is to be superimposed;
obtaining, of an image outline of the clothing image, a first outline that is the image outline other than openings formed in clothing;
setting, as a drawing restriction area, at least some area that is on the outside of the clothing image in the first image and that is continuous to the first outline; and
generating a synthetic image by synthesizing the photographic subject image, from which is removed an area corresponding to the drawing restriction area, with the clothing image.
